(19) United States
(12) Patent Application Publication
(10) Pub. No.: US 2026/0236088 A1
(43) Pub. Date: Aug. 13, 2026

(54) INFORMATION PROCESSING DEVICE, INFORMATION PROCESSING METHOD, AND PROGRAM

(71) Applicant: Sony Group Corporation, Tokyo (JP)

(72) Inventor: Forrest MATTHEW, Kanagawa (JP)

(73) Assignee: Sony Group Corporation, Tokyo (JP)

(21) Appl. No.: 19/156,697

(22) PCT Filed: Jan. 19, 2024
(86) PCT No.: PCT/JP2024/001414

§ 371 Date: Aug. 14, 2025

(30) Foreign Application Priority Data
Mar. 13, 2023 (JP) 2023-038534

(51) Int. Cl. G06F 3/01; G06Q 30/0207

(52) U.S. Cl. CPC G06F 3/011; G06Q 30/0207

(57) ABSTRACT

Evaluation of actions of a user in multiple virtual spaces is made possible. Provided is an information processing device including an acquiring section that acquires first evaluation information regarding an action of a user in a first virtual space and second evaluation information regarding an action of the user in a second virtual space, and an evaluation value calculating section that calculates a first evaluation value of the user based on the first evaluation information and an evaluation criterion associated with the first virtual space and a second evaluation value of the user based on the second evaluation information and an evaluation criterion associated with the second virtual space, in which the evaluation criterion associated with the first virtual space is different from the evaluation criterion associated with the second virtual space.

### TECHNICAL FIELD

The present disclosure relates to an information processing device, an information processing method, and a program.

### BACKGROUND ART

These days, a technology of providing, by a virtual space server, a virtual space in which various kinds of virtual objects such as 3D models and 2D images are disposed is known. Users can experience the virtual space with use of user terminals in various forms such as smartphones, HMDs (head-mounted displays), or PCs. In the virtual space, an avatar corresponding to the user and being operable by the user may be disposed. Further, in the virtual space, the user can interact with other users through avatars.

For example, PTL 1 discloses a technology of evaluating an action of a user who participates in the virtual space through an avatar. More specifically, participation in an event held in the virtual space, behavior of the user at the event, and winning or losing in the game at the event are evaluated.

### CITATION LIST

### Patent Literature

PTL 1: JP 2012-014676A

### SUMMARY

### Technical Problem

In recent years, since a number of virtual spaces are being provided, a case where one user participates in multiple virtual spaces is assumed. Yet, PTL 1 described above gives no consideration on evaluating the actions of each user in multiple virtual spaces.

In light of such a situation, the present disclosure proposes an information processing device, an information processing method, and a program that are capable of evaluating actions of a user in multiple virtual spaces.

### Solution to Problem

According to the present disclosure, there is provided an information processing device including an acquiring section that acquires first evaluation information regarding an action of a user in a first virtual space and second evaluation information regarding an action of the user in a second virtual space, and an evaluation value calculating section that calculates a first evaluation value of the user based on the first evaluation information and an evaluation criterion associated with the first virtual space and a second evaluation value of the user based on the second evaluation information and an evaluation criterion associated with the second virtual space, in which the evaluation criterion associated with the first virtual space is different from the evaluation criterion associated with the second virtual space.

Further, according to the present disclosure there is provided an information processing method including, by a processor, acquiring first evaluation information regarding an action of a user in a first virtual space and second evaluation information regarding an action of the user in a second virtual space, and calculating a first evaluation value of the user based on the first evaluation information and an evaluation criterion associated with the first virtual space and a second evaluation value of the user based on the second evaluation information and an evaluation criterion associated with the second virtual space, in which the evaluation criterion associated with the first virtual space is different from the evaluation criterion associated with the second virtual space.

Still further, according to the present disclosure, there is provided a program for causing a computer to function as an acquiring section that acquires first evaluation information regarding an action of a user in a first virtual space and second evaluation information regarding an action of the user in a second virtual space, and an evaluation value calculating section that calculates a first evaluation value of the user based on the first evaluation information and an evaluation criterion associated with the first virtual space and a second evaluation value of the user based on the second evaluation information and an evaluation criterion associated with the second virtual space, in which the evaluation criterion associated with the first virtual space is different from the evaluation criterion associated with the second virtual space.

### BRIEF DESCRIPTION OF DRAWINGS

FIG. 1 is a view illustrating an overall configuration of an information processing system 1 according to an embodiment of the present disclosure.

FIG. 2 is a view illustrating an outline of evaluations made in the information processing system 1 according to the embodiment of the present disclosure.

FIG. 3 is a block diagram illustrating an example of a configuration of a metaverse server 20 according to the present embodiment.

FIG. 4 is a view explaining a method for other users to make evaluations according to the present embodiment.

FIG. 5 is a view illustrating an example of evaluation items according to the present embodiment.

FIG. 6 is a view illustrating another example of evaluation items according to the present embodiment.

FIG. 7 is a view illustrating yet another example of evaluation items according to the present embodiment.

FIG. 8 is a block diagram illustrating an example of a configuration of a management server 30 according to the present embodiment.

FIG. 9 is a view illustrating examples of a weight of an evaluation value and giving of a reward according to the present embodiment.

FIG. 10 is a view illustrating examples of a weight of an evaluation value and giving of a reward according to the present embodiment.

FIG. 11 is a view illustrating an example of visualizing a cross-platform trust level of a user according to the present embodiment.

FIG. 12 is a view illustrating an example of visualizing a thanks point history of the user according to the present embodiment.

FIG. 13 is a sequence diagram illustrating a flow of operation processing of the information processing system according to the present embodiment.

FIG. 14 is a block diagram illustrating an example of a configuration of a metaverse server 22 according to a modification of the present embodiment.

FIG. 15 is a sequence diagram illustrating a flow of operation processing of the information processing system according to a modification of the present embodiment.

### DESCRIPTION OF EMBODIMENT

A preferred embodiment of the present disclosure is described in detail below with reference to the attached drawings. Note that, in the present specification and the drawings, constituent elements having substantially the same functions and configurations are denoted by the same reference signs to omit any redundant explanation.

Further, the description is given in the following order.
1. Configuration
   1-1. System configuration
   1-2. Configuration of Metaverse Server 20
   1-3. Configuration of Management Server 30
2. Operation Processing
3. Modifications
   3-1. First Modification
   3-2. Second Modification
   3-3. Third Modification
4. Supplements

### 1. Configuration

An information processing system according to the embodiment of the present disclosure is specifically described with use of the drawings.

### 1-1. System Configuration

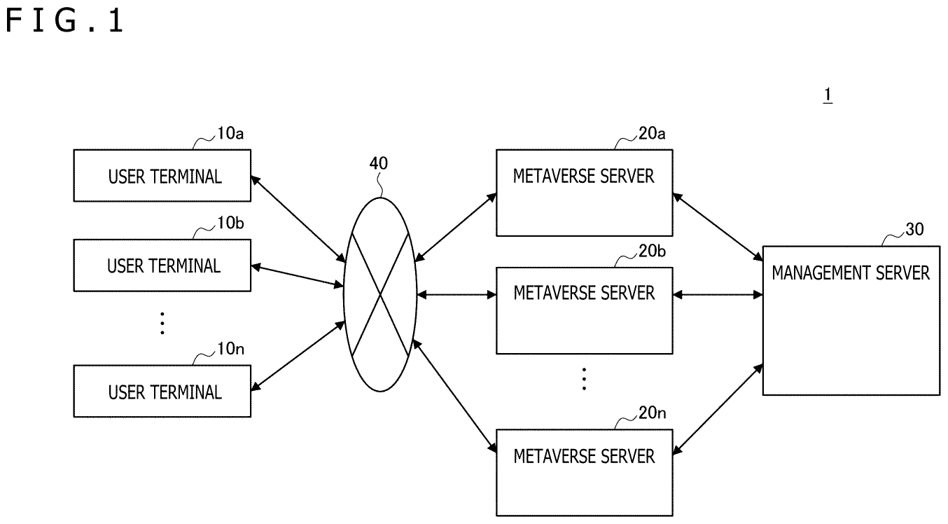

FIG. 1 is a view illustrating an overall configuration of an information processing system 1 according to the embodiment of the present disclosure. The information processing system 1 according to the present embodiment includes one or more metaverse servers 20 (20a, . . . , 20n), a management server 30 (an example of an information processing device), and one or more user terminals 10 (10a, . . . , 10n) that are used by respective users.

The metaverse server 20 builds a metaverse (virtual space) and provides, as needed, to the user terminals 10, metaverse information (virtual space information) necessary for rendering the metaverse, via a network 40. The metaverse server 20 can be provided for each different metaverse. The multiple metaverse servers 20 may be physical servers separate from one another or separate virtual servers that are operated by one physical server.

Metaverse information refers to, for example, map data of the metaverse and information (three-dimensional position, posture, and the like) regarding the virtual object disposed in the metaverse. According to the present embodiment, a metaverse video based on a user viewpoint is rendered on the user terminal 10 in reference to the metaverse information.

The metaverse server 20 evaluates the actions of a user in the metaverse. Further, the metaverse server 20 acquires evaluations made by other users or an operator of the relevant metaverse on the actions of the user in the metaverse. Specific evaluations to be made on specific actions in each of the metaverse servers 20 are assumed to differ for each metaverse.

Note that, in the present specification, the action of the user in the metaverse refers to the action of the avatar of the user in the metaverse.

The user terminal 10 is an information processing terminal used by a user. The user terminal 10 is implemented, for example, by a smartphone, a tablet terminal, a PC (personal computer), an HMD (head mounted display) that covers the whole vision, a glass-type display device, a projector, or the like. In the user terminal 10, information used for rendering the virtual object to be disposed in the metaverse (for example, a 3D model, a video, a 2D image, and the like) may be downloaded in advance.

The management server 30 calculates an evaluation value for the actions of the relevant user in reference to pieces of information regarding evaluations (hereinafter also referred to as the evaluation information) made on the actions of each user in each metaverse that are received from each of the multiple metaverse servers 20. Note that the management server 30 and the multiple metaverse servers 20 can be connected to each other via a network (not illustrated).

As described above, a number of virtual spaces are being provided in recent years, and a case where one user participates in multiple virtual spaces is assumed. Yet, PTL 1 described above gives no consideration on evaluating the actions of each user in multiple virtual spaces.

Hence, according to the embodiment of the present disclosure, calculating an evaluation value based on an evaluation criterion associated with each virtual space for the actions of each user in multiple virtual spaces may realize a more appropriate evaluation.

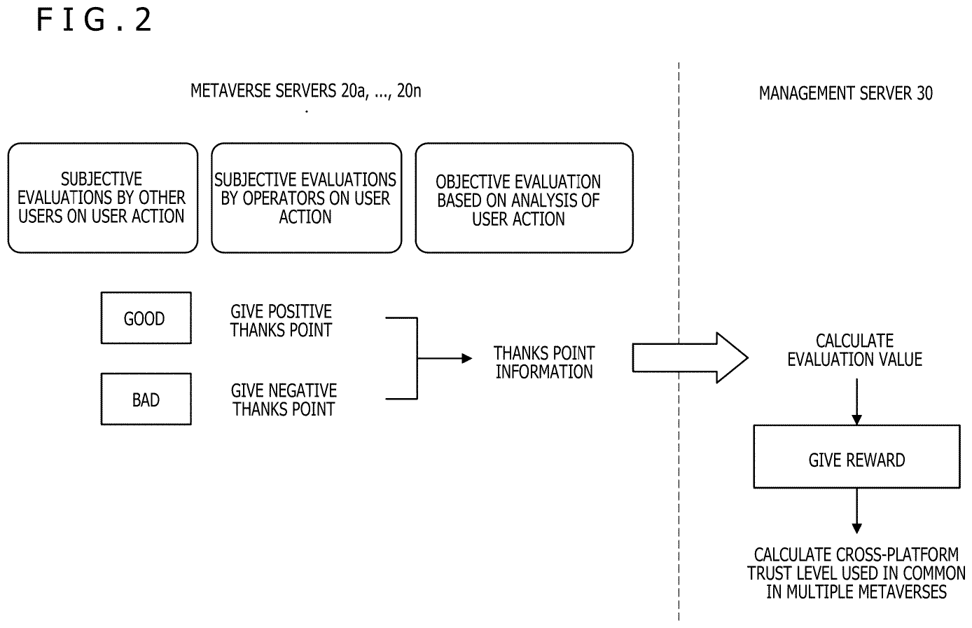

FIG. 2 is a view illustrating an outline of evaluations made in the information processing system 1 according to the embodiment of the present disclosure. As illustrated in FIG. 2, in the metaverse servers 20a through 20n, subjective evaluations by other users, subjective evaluations by the operators, or objective evaluations based on an analysis of the user action are made on the actions of the user. Specifically, a positive thanks point is given as a good evaluation, while a negative thanks point is given as a bad evaluation. Note that the evaluation method is not limited to such an example, and only good evaluations may be made.

Next, the metaverse servers 20a through 20n transmit thanks point information (one example of the evaluation information) of each user to the management server 30. The management server 30 calculates the evaluation value in reference to the thanks point information. At this time, the management server 30 can more appropriately evaluate each of the actions in the metaverse under different situations and calculate an evaluation value used in common in multiple metaverses, by calculating the evaluation values with use of an evaluation criterion (for example, weight information) associated with the respective metaverse.

The management server 30 may give a reward to the user according to the calculated evaluation value. Rewards may be given by an operator of the corresponding metaverse. Moreover, an item indicating the trustworthiness of the user (hereinafter also referred to as a trustworthiness indicating item) may be given as the reward. Making it possible to check the trustworthiness indicating item owned by the counterpart user in each metaverse allows one to understand that the counterpart user is a trustworthy person and thereby assists safe and secure exchange.

Moreover, the management server 30 may sum up the evaluation value for each metaverse of a user and calculate a trust level that is used in common in multiple metaverses (hereinafter also referred to as the cross-platform trust level). Allowing users to check the cross-platform trust level of the counterpart user in each metaverse makes it possible for the users to get hold of the overall trust level of the counterpart user and assists more safe and secure exchange.

Further, allowing users to mutually check the trustworthiness indicating item or the cross-platform trust level in each metaverse is expected to prompt each user to rethink his/her own action and to take a better action.

The outline of the information processing system 1 according to the embodiment of the present disclosure has been described above. Note that the system configuration illustrated in FIG. 1 is one example, and the present disclosure is not limited to the example.

Specific configurations of the devices included in the information processing system 1 according to the present embodiment will next be described with reference to the drawings.

### 1-2. Configuration of Metaverse Server 20

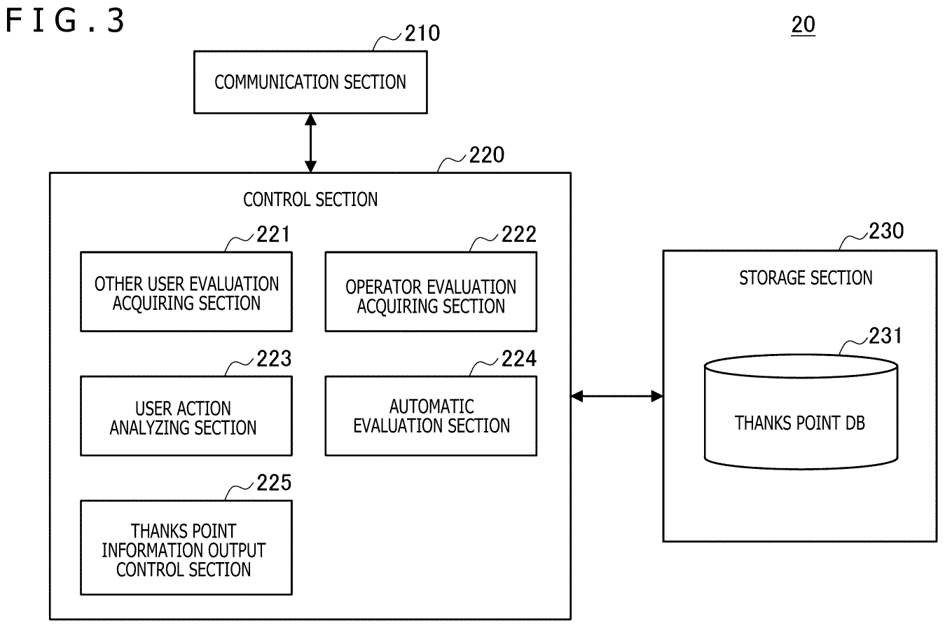

FIG. 3 is a block diagram illustrating an example of a configuration of the metaverse server 20 according to the present embodiment. As illustrated in FIG. 3, the metaverse server 20 includes a communication section 210, a control section 220, and a storage section 230.

### Communication Section 210

The communication section 210 includes a transmitting section that transmits data to an external device and a receiving section that receives data from an external device. The communication section 210 according to the present embodiment may establish communication connection with an external device or the Internet by using, for example, a wired or wireless LAN (Local Area Network), Wi-Fi (registered trademark), Bluetooth (registered trademark), a mobile communication network (LTE (Long Term Evolution), 4G (fourth generation mobile communication system), or 5G (fifth generation mobile communication system)), and the like.

### Control Section 220

The control section 220 functions as an arithmetic processing device and a control device and controls the overall operation in the metaverse server 20 in accordance with various kinds of programs. The control section 220 is implemented by an electronic circuit such as a CPU (Central Processing Unit) or a microprocessor, for example. Further, the control section 220 may include a ROM (Read Only Memory) that stores programs, arithmetic parameters, and the like to be used and a RAM (Random Access Memory) that temporarily stores parameters and the like that change as appropriate.

Further, the control section 220 also functions as an other user evaluation acquiring section 221, an operator evaluation acquiring section 222, a user action analyzing section 223, an automatic evaluation section 224, and a thanks point information output control section 225.

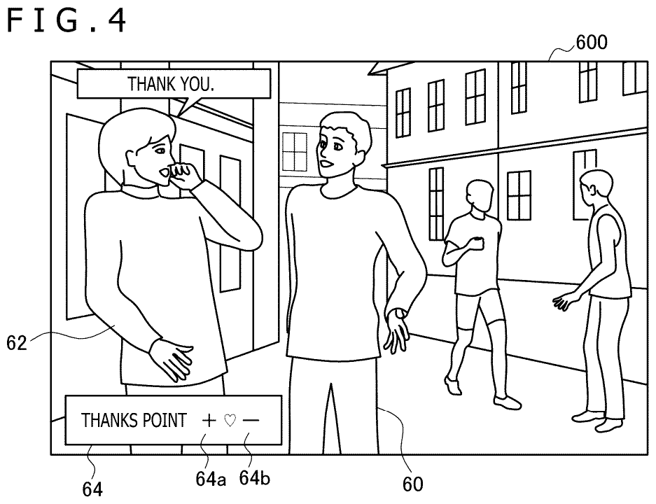

The other user evaluation acquiring section 221 acquires evaluations of other users made on the action of the user. Acquiring the evaluations of other users is described with reference to FIG. 4. FIG. 4 is a view explaining a method for other users to make evaluations according to the present embodiment.

An example illustrated in FIG. 4 assumes a scene where a user avatar 60 and an other user avatar 62 are having a conversation by text in a metaverse. A metaverse video screen 600 illustrated in FIG. 4 is an example of a screen displayed on a display section of the user terminal 10 used by the other user operating the other user avatar 62. The other user taps a plus button 64a of a thanks point button display 64 on the metaverse video screen 600 when the other user wishes to give a good evaluation on the action of the counterpart user, as exemplified by a case where the other user receives valuable information in response to a question the other user has asked the user avatar 60. On other hand, the other user taps a minus button 64b when the other user wishes to give a bad evaluation on the action of the counterpart user, for example, when the counterpart user has made an insulting remark. Note that, on the metaverse video screen 600, a display clearly indicating the person evaluated by the thanks point button may further be displayed.

The other user evaluation acquiring section 221 acquires such evaluations made by other users on the action of the user in the metaverse and stores the evaluations in a thanks point DB 231 in association with the evaluated user. Specifically, the other user evaluation acquiring section 221 adds a point to the thanks points of the user who is evaluated, according to a tap on the plus button 64a, and subtracts a point from the thanks points of the user who is evaluated, according to a tap on the minus button 64b. The thanks point according to the present embodiment is one example of the evaluation information.

The operator evaluation acquiring section 222 acquires an operator evaluation made by an operator of the metaverse on an action of the user. The operator gives a positive thanks point when the operator wishes to give a good evaluation on the action of the user and gives a negative thanks point when the operator wishes to give a bad evaluation on the action of the user. For example, one possible case is giving a good evaluation to a user who has given other users tips for enjoying the concert, a user who has contributed to the success of the concert, or the like when the operator held a concert in the metaverse. Meanwhile, another possible case is giving a bad evaluation to a user who has obstructed the concert. The operator evaluation acquiring section 222 acquires such evaluations of the operator made on the action of the user in the metaverse and stores the evaluation in the thanks point DB 231 in association with the evaluated user. Note that the operator can give, to the user, bonuses (invitation to a special event or an upcoming event, etc.) that are valuable in the metaverse, other than giving a positive thanks point.

The user action analyzing section 223 analyzes the action of each user in the metaverse. Specifically, the user action analyzing section 223 analyzes the user action to be evaluated, according to predetermined evaluation item information in which the user actions to be evaluated and the evaluation details are defined. The user actions to be evaluated that are defined in the predetermined evaluation item information differ for each metaverse (attribute of metaverse). For example, in a case where the metaverse is a concert (the attribute of the metaverse is a concert), the specific actions taken by the user avatar in the concert venue are analyzed.

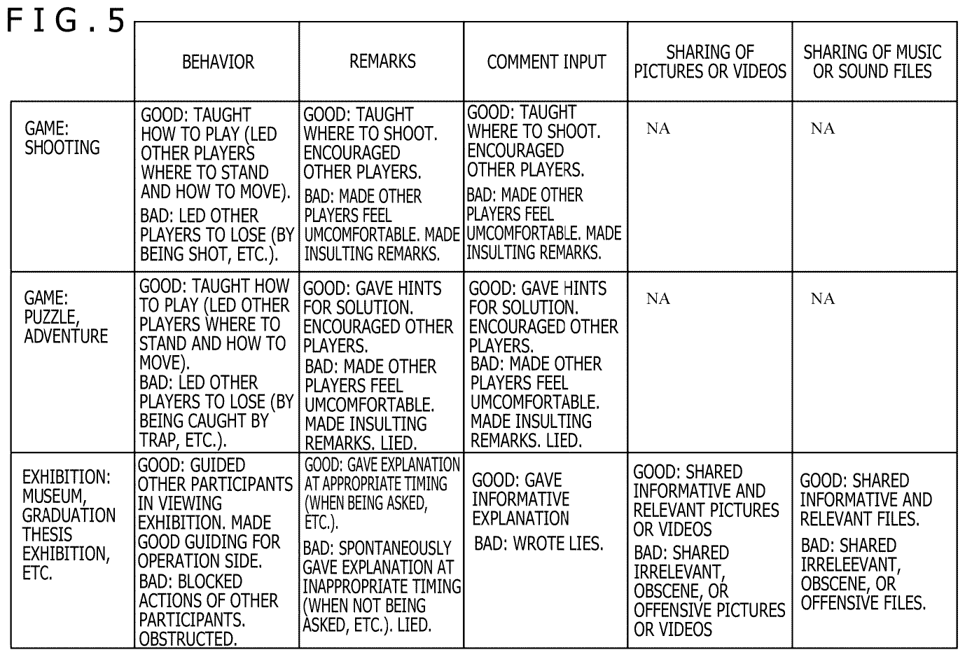

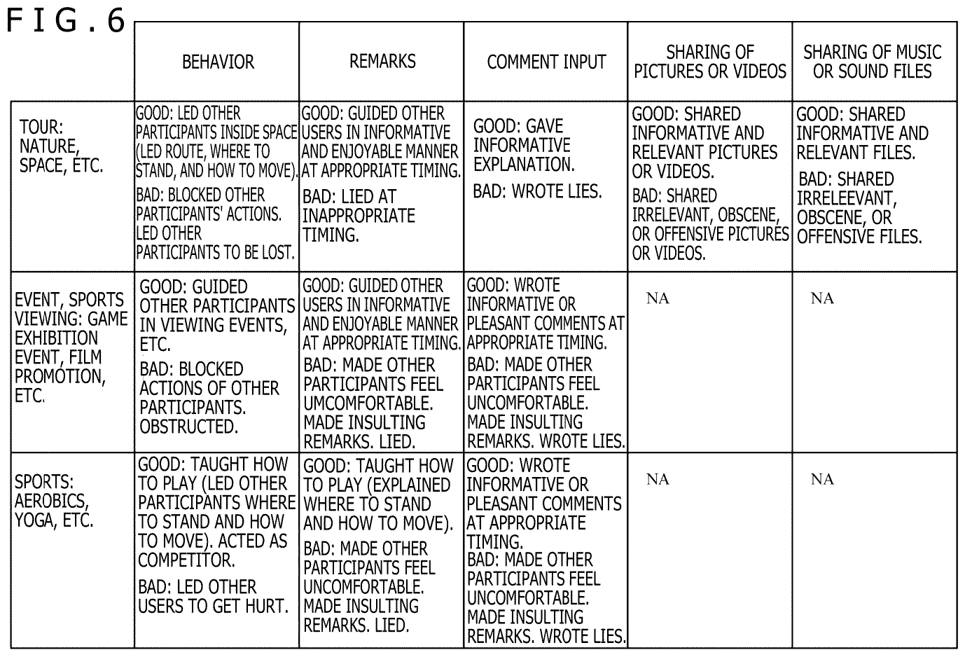

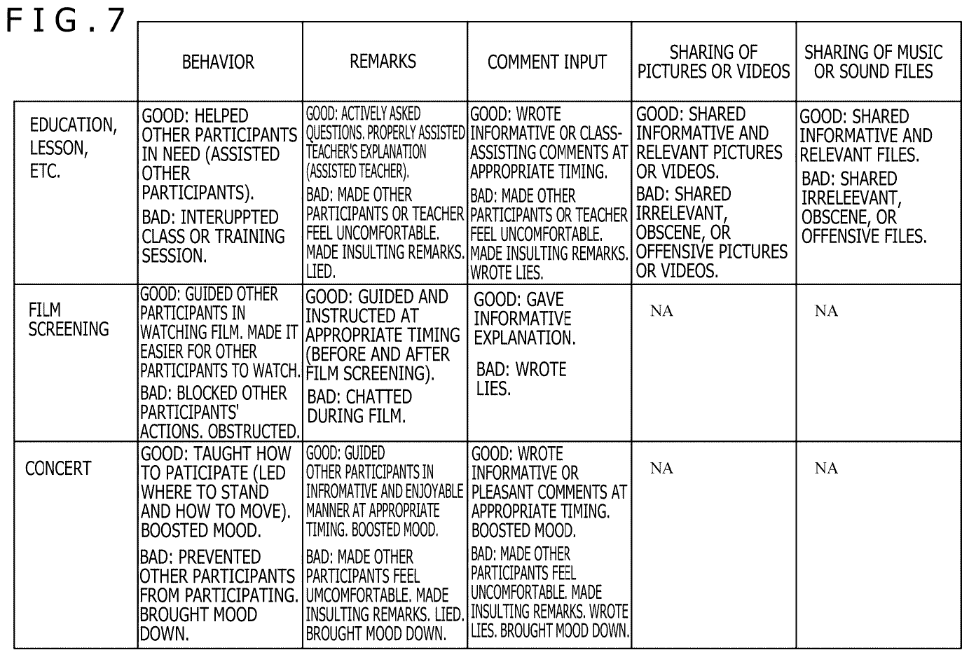

Here, FIGS. 5 through 7 illustrate examples of evaluation items according to the present embodiment. As illustrated in FIGS. 5 through 7, examples of the user actions (user avatar actions) to be defined in the evaluation items include behavior, remarks, comment input, sharing of pictures or videos, and sharing of music or sound files. Specific user actions to be evaluated differ depending on the attribute of the metaverse (for example, a game type, an exhibition, a tour, an event, sports viewing, sports, education, lesson, film screening, a concert, and the like). For example, as illustrated in FIGS. 5 through 7, in a case where the attribute of the metaverse is any of a game, an event, sports viewing, sports, film screening, and a concert, sharing of pictures or videos and sharing of music or sound files may be excluded from the evaluation items since such actions cannot be performed in the relevant metaverse. Note that the user actions to be evaluated as illustrated in FIGS. 5 through 7 are examples, and the present embodiment is not limited to such examples.

The automatic evaluation section 224 makes an evaluation on the user according to predetermined evaluation items, in reference to a result of analysis of the user action by the user action analyzing section 223. The evaluation details defined in the predetermined evaluation item information differ for each metaverse (attribute of metaverse). For example, in a case where the metaverse is a concert (the attribute of the metaverse is a concert), giving a good evaluation on the action of dancing and boosting the mood at the concert venue or the action of performing an emote of cheering an artist, for example, is defined. Further, the automatic evaluation section 224 may give a thanks point to the user by recognizing such words as “thanks” or “you saved me” being given to the user from other users by the user action analyzing section 223.

The automatic evaluation section 224 gives, in reference to the analysis result, a positive thanks point when a good evaluation is made on the action of the user and a negative thanks point when a bad evaluation is made on the action of the user. The automatic evaluation section 224 stores such evaluations made on the actions of the user in the metaverse in the thanks point DB 231 in association with the evaluated user.

As illustrated in FIGS. 5 through 7, specific actions to be evaluated as being good or bad differ for each metaverse (the attribute of the metaverse). Note that different metaverses may partially have the same evaluation details defined. The evaluation details illustrated in FIGS. 5 through 7 are examples, and the present embodiment is not limited to such examples. Further, while the evaluations to be made by other users and the evaluations to be made by the operator can be made as desired, evaluations can also be made in accordance with such evaluation items illustrated in FIGS. 5 through 7. Further, the control section 220 may prompt the user to make an evaluation as desired, by displaying the thanks point button display 64 on the metaverse video screen 600 when an action to be evaluated is detected by an analysis of the user action by the user action analyzing section 223.

Further, as one example of the evaluation details, a much better evaluation may be made on the user who has been given good evaluations (has been given positive thanks points) from other users. Note that, other than giving a good evaluation (giving a positive thanks point) by the automatic evaluation section 224, the control section 220 can give to the user bonuses that are valuable in the metaverse.

The thanks point information output control section 225 performs control of transmitting information regarding the thanks points of each user stored in the thanks point DB 231 from the communication section 210 to the management server 30.

### Storage Section 230

The storage section 230 is implemented by a ROM that stores programs, arithmetic parameters, and the like used for the processing in the control section 220 and a RAM that temporarily stores parameters and the like that change as appropriate.

Further, the storage section 230 includes the thanks point DB (database) 231 that stores the thanks points of each user.

The configuration of the metaverse server 20 has specifically been described above, but the configuration of the metaverse server 20 according to the present disclosure is not limited to the example illustrated in FIG. 3. For example, the metaverse server 20 may not necessarily include all of the configurations illustrated in FIG. 3. Moreover, the metaverse server 20 may be implemented by multiple devices.

### 1-3. Configuration of Management Server 30

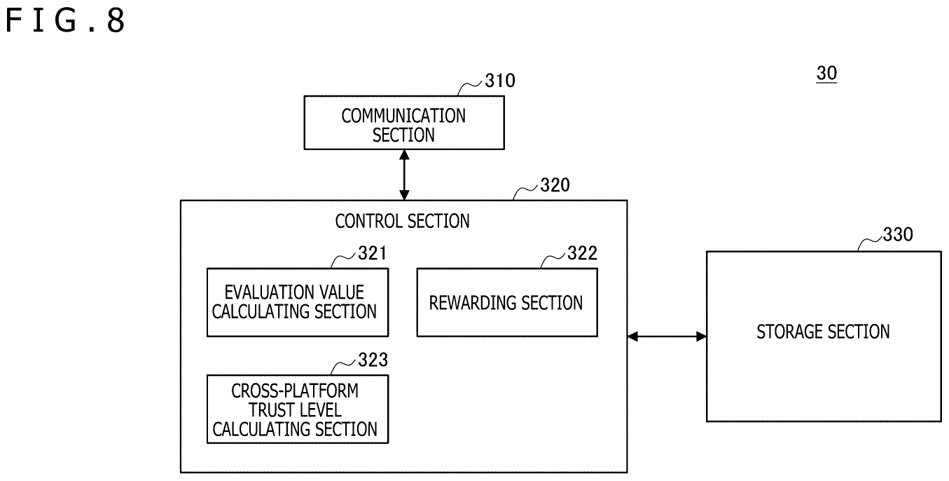

FIG. 8 is a block diagram illustrating an example of a configuration of the management server 30 according to the present embodiment. As illustrated in FIG. 8, the management server 30 includes a communication section 310, a control section 320, and a storage section 330.

### Communication Section 310

The communication section 310 includes a transmitting section that transmits data to an external device and a receiving section that receives data from an external device. The communication section 310 according to the present embodiment may establish communication connection with an external device or the Internet by using, for example, a wired or wireless LAN (Local Area Network), Wi-Fi (registered trademark), Bluetooth (registered trademark), a mobile communication network (LTE (Long Term Evolution), 4G (fourth generation mobile communication system), and 5G (fifth generation mobile communication system) ), and the like.

For example, the communication section 310 also functions as an acquiring section that receives (acquires) information (evaluation information) regarding the thanks points of each user from the metaverse server 20. Further, the communication section 310 transmits a trustworthiness indicating item (an example of a reward) or a trustworthiness indicating item and a cross-platform evaluation value of each user to the metaverse server 20.

### Control Section 320

The control section 320 functions as an arithmetic processing device and a control device and controls the overall operation in the management server 30 in accordance with various kinds of programs. The control section 320 is implemented by, for example, an electronic circuit such as a CPU (Central Processing Unit) or a microprocessor. Further, the control section 320 may include a ROM (Read Only Memory) that stores programs, arithmetic parameters, and the like to be used and a RAM (Random Access Memory) that temporarily stores the parameters and the like that change as appropriate.

Further, the control section 320 also functions as an evaluation value calculating section 321, a rewarding section 322, and a cross-platform trust level calculating section 323.

The evaluation value calculating section 321 calculates the evaluation values for the user actions. Specifically, the evaluation value calculating section 321 calculates the evaluation values by using an evaluation criterion associated with the metaverse (virtual space) in reference to the thanks point information (one example of the information regarding the evaluation made on a user action). Examples of the evaluation criterion associated with the metaverse include a weight value. The weight value may be set beforehand for each metaverse (the attribute of the metaverse) or may be set according to the scale of the metaverse (specifically, the number of people participating in the metaverse). Information indicating the scale of the metaverse can be transmitted from the metaverse server 20 together with information regarding the thanks points.

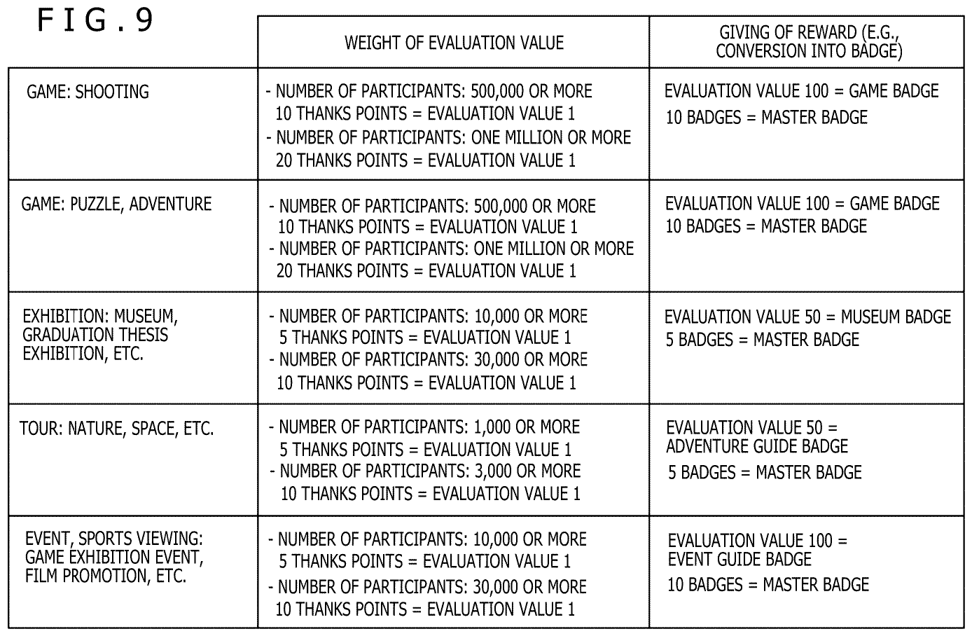

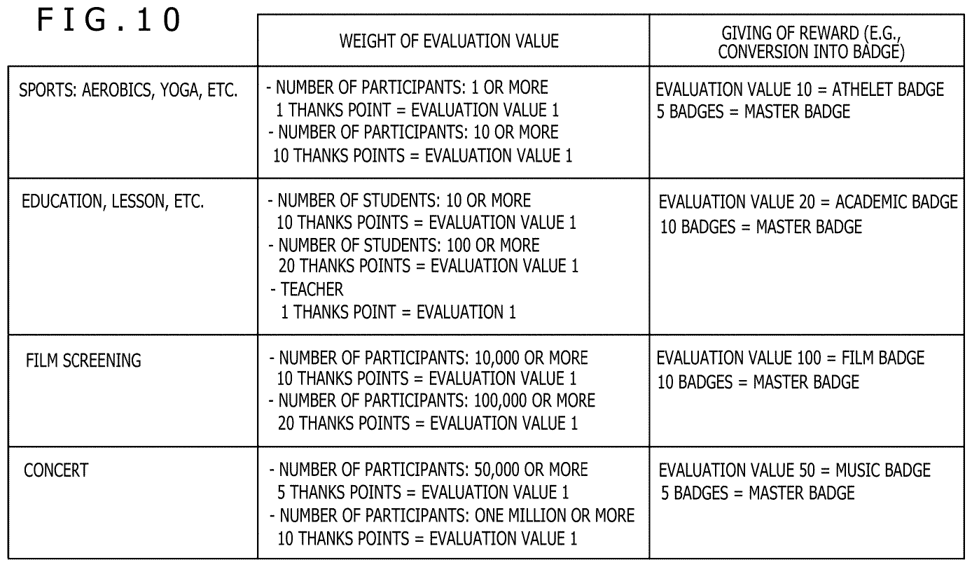

FIGS. 9 and 10 are each a view illustrating examples of the weight of the evaluation value and giving of a reward according to the present embodiment. As illustrated in FIGS. 9 and 10, as an example, the evaluation value of each user is calculated with use of weighting that is different depending on the thanks points of each user, for each metaverse (attribute of the metaverse). For example, in the game metaverse illustrated in FIG. 9, in a case where the number of participants is 500,000 or more, 10 thanks points are converted into an evaluation value 1, and in a case where the number of participants is one million or more, 20 thanks points are converted into the evaluation value 1. Further, for example, in the exhibition metaverse illustrated in FIG. 9, in a case where the number of participants is 10,000 or more, 5 thanks points are converted into the evaluation value 1, and in a case where the number of participants is 30,000 or more, 10 thanks points are converted into the evaluation value 1.

The evaluation value calculating section 321 stores the calculated evaluation value of each user in the storage section 330 in association with each user.

The rewarding section 322 gives a reward based on the evaluation value calculated by the evaluation value calculating section 321. The rewarding section 322 may give, as a reward, a trustworthiness indicating item, a bonus, or a virtual currency, for example. The trustworthiness indicating item may, for example, be a badge, a crown, a trophy, or the like. The trustworthiness indicating item may be in a form that can be attached to the avatar and can be visually confirmed.

In FIGS. 9 and 10, as one example of giving a reward, an example of converting the evaluation value into a badge is illustrated. Specific badges to be given based on specific evaluation values differ for each metaverse (attribute of the metaverse). For example, in the game metaverse illustrated in FIG. 9, in exchange for the evaluation value 100 of the user, a badge of the game (a sign indicating that the user is a trustworthy person in the game) is given. Further, in the exhibition metaverse illustrated in FIG. 9, in exchange for the evaluation value 50 of the user, a museum badge is given if the exhibition represents a museum.

Further, in a case where the number of badges owned by the user reaches a predetermined number, the rewarding section 322 may give a master badge which is a sign indicating a further higher trust level, in exchange for the owned badges. For example, in the game metaverse illustrated in FIG. 9, the master badge is given in exchange for 10 game badges. Further, for example, in the exhibition metaverse illustrated FIG. 9, the master badge is given in exchange for 5 museum badges.

The rewarding section 322 stores the information regarding giving of rewards to the user in the storage section 330 in association with each user. Further, the information regarding the giving of rewards to the user is transmitted to the metaverse server 20. Note that, for the information regarding the giving of rewards to the user, an NET (Non-Fungible Token) may be used. For example, the trustworthiness indicating items to be given to the user as one example of rewards for the user may be provided by a mechanism of an NFT (Non-Fungible Token).

The cross-platform trust level calculating section 323 calculates a cross-platform trust level (cross-platform evaluation value) of a user that is used in common in multiple metaverses, according to the total evaluation value of the user (the total of the evaluation values of the relevant user in each metaverse) or the trustworthiness indicating items owned by the user. The cross-platform trust level calculating section 323 may determine whether the cross-platform trust level is high, intermediate, or low, according to a predetermined threshold value. For example, the cross-platform trust level calculating section 323 determines whether the cross-platform trust level is high, intermediate, or low, according to the total number of trustworthiness indicating items owned by the user. Here, the total number of trustworthiness indicating items refers to the total number of badges associated with each metaverse. Further, the cross-platform trust level calculating section 323 may determine whether the cross-platform trust level is high, intermediate, or low, in consideration of the levels of the trustworthiness indicating items, in addition to the total number of trustworthiness indicating items owned by the user. For example, the master badge is higher in level than ordinary badges. Further, the cross-platform trust level calculating section 323 may calculate the score of the cross-platform trust level from the total evaluation value of the user.

The information regarding the calculated cross-platform trust level is transmitted to the metaverse server 20. Further, the information regarding the cross-platform trust level may be provided by a mechanism of an NFT (Non-Fungible Token).

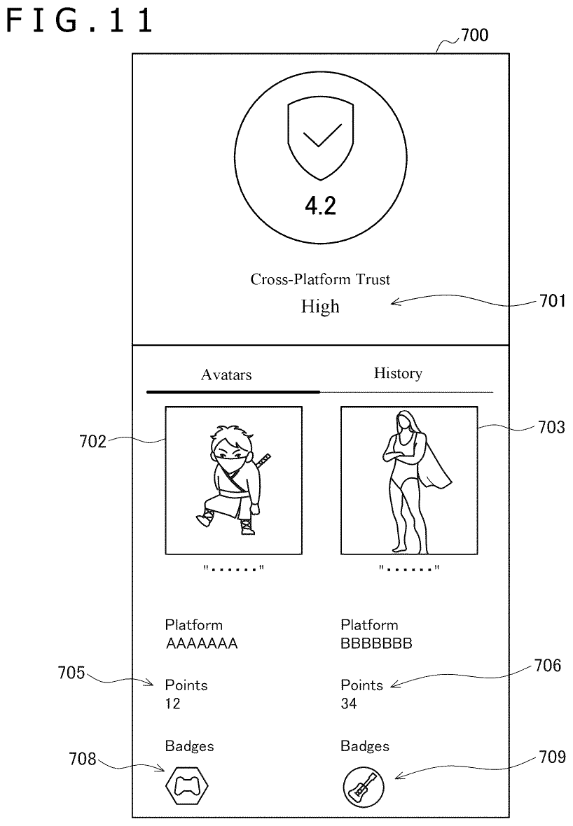

FIG. 11 is a view illustrating an example of visualizing the cross-platform trust level of a user according to the present embodiment. A screen 700 illustrated in FIG. 11 includes a cross-platform trust level 701, avatars 702 and 703 used in each metaverse (metaverse platform), thanks points 705 and 706 gained in each metaverse, and the acquired badges 708 and 709 associated with each metaverse of the user. The cross-platform trust level 701 of the user may, in addition to being displayed to be high, intermediate, or low, be displayed together with the score of the cross-platform trust level (4.2 in the example illustrated in FIG. 11) as illustrated in an upper portion of the screen 700.

The screen 700 can be browsed by other users who participate in one metaverse. The other users can intuitively recognize from the cross-platform trust level or the acquired badges of the counterpart user whether the counterpart user is a trustworthy person or not. Further, the other users can get hold of the evaluations (thanks points) of the counterpart user in other metaverses. In such a manner, in the present embodiment, evaluations made on the user in multiple metaverses are visualized.

Note that the trustworthiness indicating items such as the badges may be visually recognized by other users in the metaverse by being attached to the avatar. Allowing trustworthiness indicating items associated with other metaverses to be attached makes it possible for other users to intuitively recognize which user has a detailed knowledge in which field (the attribute of the metaverse such as music, game, academia, film, or specific artist), how active the user is, and whether the user is a trustworthy person.

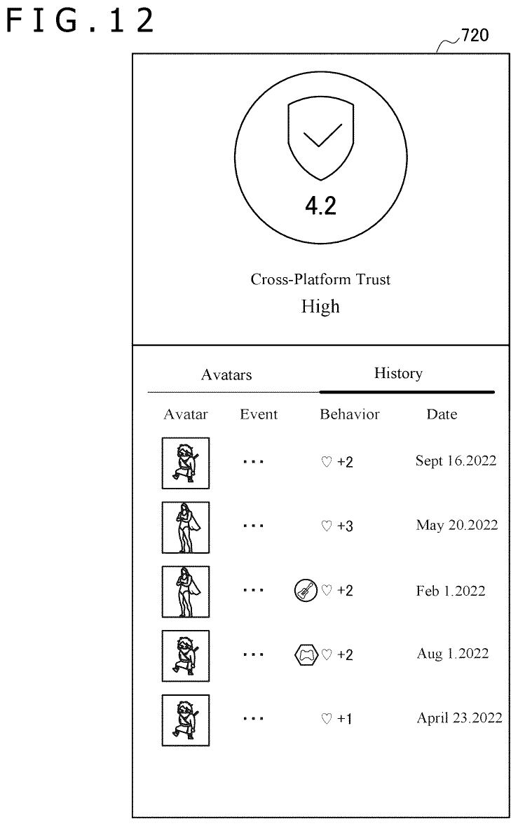

FIG. 12 is a view illustrating an example of visualizing a thanks point history of a user according to the present embodiment. As illustrated in a screen 720 of FIG. 12, when and in which event the specific avatars owned by the user participated and were given a thanks point or a badge are displayed. As one example here, a case where the user participated in an event held in the metaverse, gained a good evaluation on his/her action, and was given a thanks point is assumed, but the present embodiment is not limited to such an example. The badge may be displayed according to the time point at which the badge is given by the management server 30.

The information regarding the thanks points of each user that is transmitted from the metaverse server 20 to the management server 30 includes information indicating when and in which event the thanks points were given, for example, and such information is shared to multiple metaverse servers 20 by the management server 30. Further, the screen 720 illustrated in FIG. 12 may also be browsed by other users who participate in one metaverse.

### Storage Section 330

The storage section 330 is implemented by a ROM that stores programs, arithmetic parameters, and the like used for the processing in the control section 320 and a RAM that temporarily stores parameters and the like that change as appropriate, for example.

The storage section 330 stores information regarding the thanks points, evaluation values, rewards, a cross-platform trust level, and the like of each user in the multiple metaverses.

The configuration of the management server 30 has specifically been described above, but the configuration of the management server 30 according to the present disclosure is not limited to the example illustrated in FIG. 8. For example, the management server 30 is not necessarily required to have all of the configurations illustrated in FIG. 8. Moreover, the management server 30 may be implemented by multiple devices.

### 2. Operation Processing

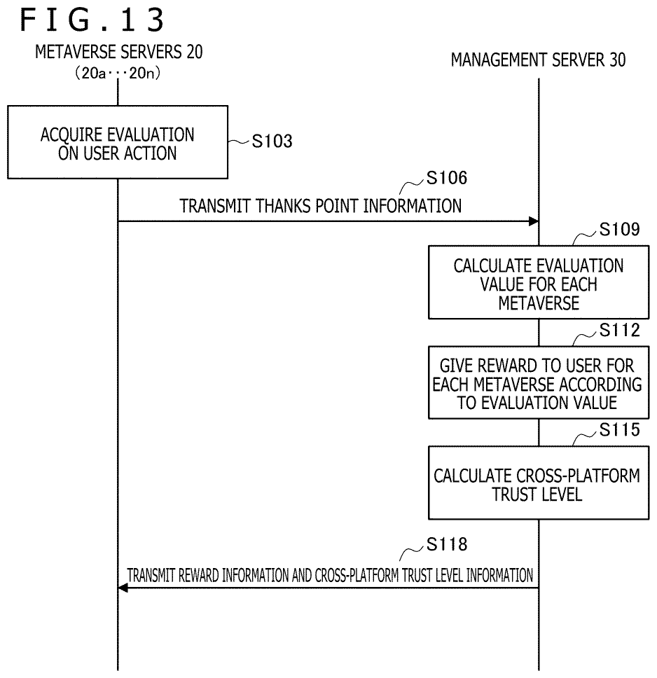

FIG. 13 is a sequence diagram illustrating a flow of operation processing of the information processing system according to the present embodiment.

As illustrated in FIG. 13, first, each of the metaverse servers 20 (each of the metaverse servers 20a through 20n) acquires evaluations made on a user action (step S103). Specifically, each of the metaverse servers 20 acquires, with regard to the user action, evaluations made by other users, an evaluation made by the operator, or an automatic evaluation based on the result of analysis of the user action. Further, for the evaluations in the metaverse servers 20, thanks points are used as one example.

Next, each of the metaverse servers 20 transmits information regarding the thanks points of each user to the management server 30 (step S106).

Thereafter, the management server 30 uses the evaluation criterion (for example, a weight value) associated with the relevant metaverse, according to the thanks points of the user obtained from the metaverse, and calculates the evaluation values for the user action in the relevant metaverse (step S109).

Subsequently, the management server 30 gives a reward to the user for each corresponding metaverse according to the evaluation value (step S112). The trustworthiness indicating item is one example of a reward.

Then, the management server 30 calculates the cross-platform trust level of the user that is used in common in multiple metaverses, according to the evaluation values or the number of trustworthiness indicating items (step S115).

Further, the management server 30 transmits reward information (information regarding the cross-platform trust level given, etc.), cross-platform trust level information, and the like to each of the multiple metaverse servers 20 (step S118). As a result, the rewards, the cross-platform trust level, and the like based on the actions of the user in each metaverse are shared by the metaverse servers 20. Further, in each metaverse, the trustworthiness indicating items and the cross-platform trust level of each user are visualized (controlled to be browsable). Consequently, each user participating in the metaverse can intuitively recognize whether other users are trustworthy people or not, for example.

The operation processing of the information processing system 1 according to the present embodiment has specifically been described above with reference to FIG. 13, but the operation processing according to the present embodiment is not limited to the example illustrated in FIG. 13.

### 3. Modifications

Next, modifications of the present embodiment are explained.

### 3-1. First Modification

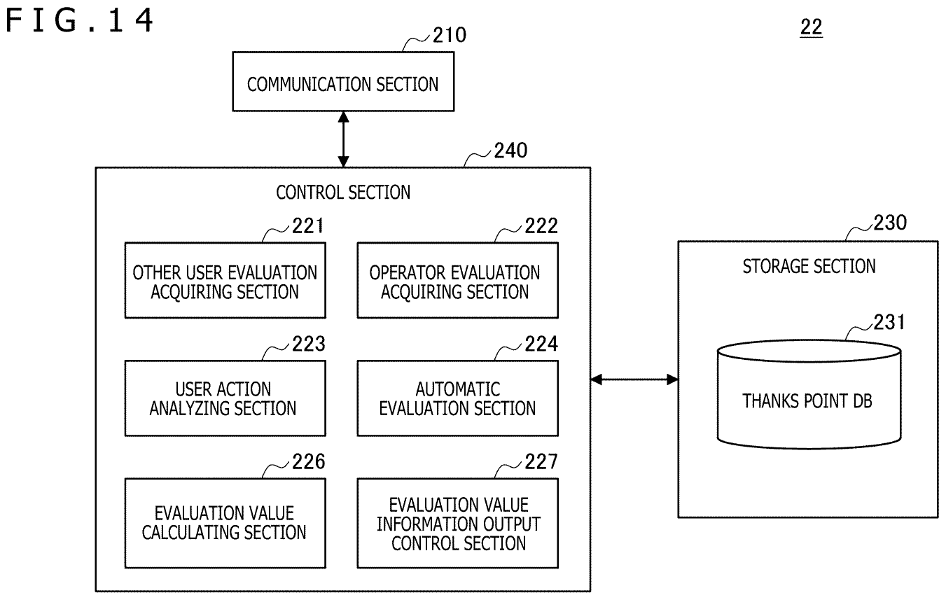

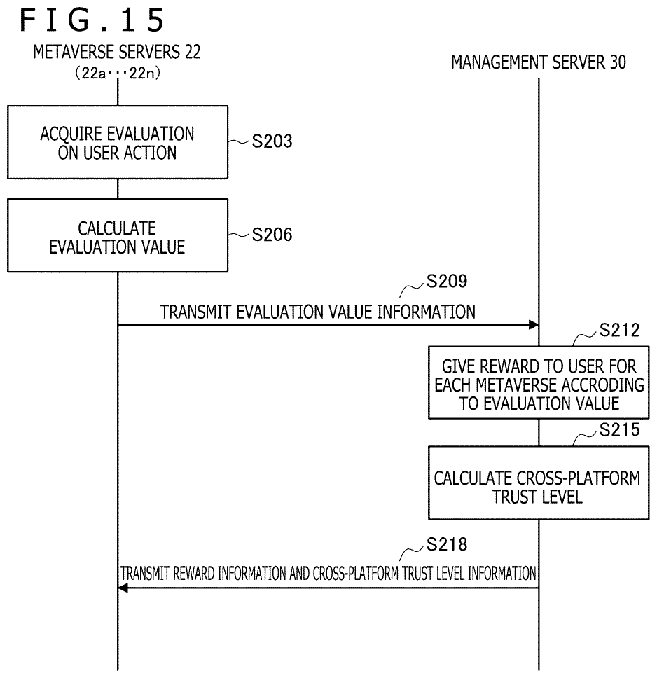

In the embodiment described above, the management server 30 calculates the evaluation values, but the present disclosure is not limited to such an example, and each metaverse server may calculate the evaluation values. In the following description, explanation is given with reference to FIGS. 14 and 15.

### Configuration

FIG. 14 is a block diagram illustrating an example of a configuration of a metaverse server 22 according to a modification of the present embodiment. As illustrated in FIG. 14, the metaverse server 22 includes the communication section 210, a control section 240, and the storage section 230. Further, the control section 240 also functions as the other user evaluation acquiring section 221, the operator evaluation acquiring section 222, the user action analyzing section 223, the automatic evaluation section 224, an evaluation value calculating section 226, and an evaluation value information output control section 227.

Here, differences from the configuration of the metaverse server 20 described with reference to FIG. 3 are mainly explained.

The evaluation value calculating section 226, similarly to the evaluation value calculating section 321 of the management server 30 illustrated in FIG. 8, calculates the evaluation values with reference to the evaluation criterion, in accordance with the evaluation information (for example, the thanks points) regarding the user action. The evaluation value information output control section 227 performs control of transmitting the information regarding the evaluation values calculated by the evaluation value calculating section 226 to the management server 30 from the communication section 210.

### Operation Processing

FIG. 15 is a sequence diagram illustrating a flow of operation processing of the information processing system according to a modification of the present embodiment.

As illustrated in FIG. 15, first, each of the metaverse servers 20 (each of the metaverse servers 20a through 20n) acquires the evaluations made on a user action (step S203). For the evaluations in the metaverse servers 20, thanks points are used as one example.

Next, each of the metaverse servers 20 uses the evaluation criterion (for example, the weight value) associated with the relevant metaverse, according to the thanks points of the user in the metaverse, and calculates the evaluation value for the user action in the relevant metaverse (step S206).

Subsequently, each of the metaverse servers 20 transmits the information regarding the evaluation value of each user to the management server 30 (step S209).

Thereafter, the management server 30 gives a reward to the user for each corresponding metaverse according to the evaluation values (step S212). The trustworthiness indicating item is one example of a reward.

Then, the management server 30 calculates the cross-platform trust level of the user that is used in common in multiple metaverses, according to the evaluation values or the number of trustworthiness indicating items (step S215).

Further, the management server 30 transmits the reward information (information regarding the cross-platform trust level given, etc.), cross-platform trust level information, and the like to each of the multiple metaverse servers 20 (step S218).

### 3-2. Second Modification

In the embodiment described above, the metaverse server 20 acquires the evaluations on a user action, but the present disclosure is not limited to such an example, and the management server 30 may perform at least part of the evaluation on a user action.

Specifically, information regarding a user action is transmitted to the management server 30 from the metaverse server 20, and the management server 30 can perform an analysis and an automatic evaluation on the user action and acquire the information regarding the evaluations made on the user action.

### 3-3. Third Modification

Further, the functions of the management server 30 may be incorporated in each metaverse server 20 (one example of the information processing device) as an extension.

### 4. Supplements

A preferred embodiment of the present disclosure has been described in detail above with reference to the attached drawings, but the present technology is not limited to such an example. A person who has ordinary knowledge in the technical field of the present disclosure would recognize that various modifications and amendments can be arrived at within the scope of the technical idea described in the claims and that such modifications and amendments naturally fall within the technical scope of the present disclosure.

For example, one or more computer programs for exerting the functions of the metaverse server 20, the management server 30, and the metaverse server 22 can be created in the hardware including the CPU, the ROM, and the RAM that is incorporated in the metaverse server 20, the management server 30, and the metaverse server 22 described above. Further, a computer-readable storage medium in which the one or more computer programs are stored is provided.

Further, the effects described in the present specification are explanatory or exemplary to the last and not limitative. That is, the technology according to the present disclosure can produce other effects obvious to persons skilled in the art from the description in the present specification, in addition to or in place of the effects described above.

Note that the present technology can also have the following configurations.
(1)

An information processing device including:
an acquiring section that acquires first evaluation information regarding an action of a user in a first virtual space and second evaluation information regarding an action of the user in a second virtual space; and
an evaluation value calculating section that calculates a first evaluation value of the user based on the first evaluation information and an evaluation criterion associated with the first virtual space and a second evaluation value of the user based on the second evaluation information and an evaluation criterion associated with the second virtual space, in which
the evaluation criterion associated with the first virtual space is different from the evaluation criterion associated with the second virtual space.
(2)

The information processing device according to (1) above, in which the evaluation criterion includes a weight value.
(3)

The information processing device according to (1) or (2) above, in which
the first evaluation information and the second evaluation information each include a result of evaluation on the action of the user based on evaluation item information associated with the respective one of the first virtual space or the second virtual space, and
the evaluation item information associated with the first virtual space is different from the evaluation item information associated with the second virtual space.
(4)

The information processing device according to any one of (1) to (3) above, further including:
a rewarding section that gives a first reward for the user associated with the first virtual space, according to the first evaluation value, and gives a second reward for the user associated with the second virtual space, according to the second evaluation value.
(5)

The information processing device according to (4) above, in which the first reward and the second reward each include a trustworthiness indicating item that is allowed to be visualized in the first virtual space and the second virtual space and that indicates trustworthiness of the user.
(6)

The information processing device according to (4) or (5) above, further including:
a transmitting section that transmits information regarding the giving of rewards to the user to the first virtual space and the second virtual space.
(7)

The information processing device according to (6) above, in which the transmitting section transmits information regarding the first reward for the user associated with the first virtual space and information regarding the second reward for the user associated with the second virtual space to the first virtual space and the second virtual space.
(8)

The information processing device according to any one of (1) to (7) above, further including:
a cross-platform evaluation value calculating section that calculates a cross-platform evaluation value of the user that is used in common in the first virtual space and the second virtual space, according to the first and second evaluation values or trustworthiness indicating items given to the user according to the first or second evaluation value.
(9)

The information processing device according to (8) above, further including:
a transmitting section that transmits information regarding the cross-platform evaluation value of the user to the first virtual space and the second virtual space.
(10)

The information processing device according to (9) above, in which the information regarding the cross-platform evaluation value is controlled to be browsable by other users in each of the first virtual space and the second virtual space.
(11)

The information processing device according to any one of (1) to (10) above, in which the evaluation information regarding the action of the user includes evaluations from other users participating in the virtual spaces or evaluations from operators of the virtual spaces.
(12)

The information processing device according to any one of (1) to (11) above, in which an NFT is used for information regarding a reward given to the user according to the first or second evaluation value.
(13)

The information processing device according to any one of (1) to (11) above, in which the actions of the user include at least any one of behavior, a remark, an input comment, sharing of pictures or videos, and sharing of music or sound files of the user in a virtual space.
(14)

An information processing method including:
by a processor,
acquiring first evaluation information regarding an action of a user in a first virtual space and second evaluation information regarding an action of the user in a second virtual space; and
calculating a first evaluation value of the user based on the first evaluation information and an evaluation criterion associated with the first virtual space and a second evaluation value of the user based on the second evaluation information and an evaluation criterion associated with the second virtual space, in which
the evaluation criterion associated with the first virtual space is different from the evaluation criterion associated with the second virtual space.
(15)

A program for causing a computer to function as:
an acquiring section that acquires first evaluation information regarding an action of a user in a first virtual space and second evaluation information regarding an action of the user in a second virtual space; and
an evaluation value calculating section that calculates a first evaluation value of the user based on the first evaluation information and an evaluation criterion associated with the first virtual space and a second evaluation value of the user based on the second evaluation information and an evaluation criterion associated with the second virtual space, in which
the evaluation criterion associated with the first virtual space is different from the evaluation criterion associated with the second virtual space.

### REFERENCE SIGNS LIST

1: Information processing system
10: User terminal
20, 22: Metaverse server
210: Communication section
220: Control Section
221: Other user evaluation acquiring section
222: Operator evaluation acquiring section
223: User action analyzing section
224: Automatic evaluation section
225: Thanks point information output control section
226: Evaluation value calculating section
227: Evaluation value information output control section
230: Storage section
231: Thanks point DB 231
30: Management server
310: Communication section
320: Control section
321: Evaluation value calculating section
322: Rewarding section
323: Cross-platform trust level calculating section
330: Storage section
40: Network

1. An information processing device comprising:
an acquiring section that acquires first evaluation information regarding an action of a user in a first virtual space and second evaluation information regarding an action of the user in a second virtual space; and
an evaluation value calculating section that calculates a first evaluation value of the user based on the first evaluation information and an evaluation criterion associated with the first virtual space and a second evaluation value of the user based on the second evaluation information and an evaluation criterion associated with the second virtual space, wherein
the evaluation criterion associated with the first virtual space is different from the evaluation criterion associated with the second virtual space.

2. The information processing device according to claim 1, wherein the evaluation criterion includes a weight value.

3. The information processing device according to claim 1, wherein
the first evaluation information and the second evaluation information each include a result of evaluation on the action of the user based on evaluation item information associated with the respective one of the first virtual space or the second virtual space, and
the evaluation item information associated with the first virtual space is different from the evaluation item information associated with the second virtual space.

4. The information processing device according to claim 1, further comprising:
a rewarding section that gives a first reward for the user associated with the first virtual space, according to the first evaluation value, and gives a second reward for the user associated with the second virtual space, according to the second evaluation value.

5. The information processing device according to claim 4, wherein the first reward and the second reward each include a trustworthiness indicating item that is allowed to be visualized in the first virtual space and the second virtual space and that indicates trustworthiness of the user.

6. The information processing device according to claim 4, further comprising:
a transmitting section that transmits information regarding the giving of rewards to the user to the first virtual space and the second virtual space.

7. The information processing device according to claim 6, wherein the transmitting section transmits information regarding the first reward for the user associated with the first virtual space and information regarding the second reward for the user associated with the second virtual space to the first virtual space and the second virtual space.

8. The information processing device according to claim 1, further comprising:
a cross-platform evaluation value calculating section that calculates a cross-platform evaluation value of the user that is used in common in the first virtual space and the second virtual space, according to the first and second evaluation values or trustworthiness indicating items given to the user according to the first or second evaluation value.

9. The information processing device according to claim 8, further comprising:
a transmitting section that transmits information regarding the cross-platform evaluation value of the user to the first virtual space and the second virtual space.

10. The information processing device according to claim 9, wherein the information regarding the cross-platform evaluation value is controlled to be browsable by other users in each of the first virtual space and the second virtual space.

11. The information processing device according to claim 1, wherein the evaluation information regarding the action of the user includes evaluations from other users participating in the virtual spaces or evaluations from operators of the virtual spaces.

12. The information processing device according to claim 1, wherein an NFT is used for information regarding a reward given to the user according to the first or second evaluation value.

13. The information processing device according to claim 1, wherein the actions of the user include at least any one of behavior, a remark, an input comment, sharing of pictures or videos, and sharing of music or sound files of the user in a virtual space.

14. An information processing method comprising:
by a processor,
acquiring first evaluation information regarding an action of a user in a first virtual space and second evaluation information regarding an action of the user in a second virtual space; and
calculating a first evaluation value of the user based on the first evaluation information and an evaluation criterion associated with the first virtual space and a second evaluation value of the user based on the second evaluation information and an evaluation criterion associated with the second virtual space, wherein
the evaluation criterion associated with the first virtual space is different from the evaluation criterion associated with the second virtual space.

15. A program for causing a computer to function as:
an acquiring section that acquires first evaluation information regarding an action of a user in a first virtual space and second evaluation information regarding an action of the user in a second virtual space; and
an evaluation value calculating section that calculates a first evaluation value of the user based on the first evaluation information and an evaluation criterion associated with the first virtual space and a second evaluation value of the user based on the second evaluation information and an evaluation criterion associated with the second virtual space, wherein
the evaluation criterion associated with the first virtual space is different from the evaluation criterion associated with the second virtual space.
